(19) United States
(12) Patent Application Publication
(10) Pub. No.: US 2008/0205416 A1
(43) Pub. Date: Aug. 28, 2008

(54) Flight control computers with ethernet based cross channel data links

(75) Inventor: Timothy J. DeChiara, Hillsdale, NJ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/710,207

(22) Filed: Feb. 23, 2007

(51) Int. Cl. H04L 12/56

(52) U.S. Cl. 370/401; 370/465

(57) ABSTRACT

According to an example embodiment, a method includes communicating between redundant Flight Control Computers (FCCs) using Cross-Channel Data Links (CCDLs) that operate in accordance with an IEEE standard Ethernet protocol.

### BACKGROUND

1. Technical Field

This disclosure relates generally to redundant Flight Control Computers (FCCs), and more particularly relates to redundant FCCs with an Ethernet-based Cross Channel Data Link (CCDL).

2. Description of the Related Art

CCDLs are used to communicate among redundant FCCs. Since traditional serial data links have much slower transfer rates than what is used for a redundant flight control system, conventional CCDLs typically use custom designs to meet the increased reliability and performance demands. However, custom designs are prone to high expense and long development cycles, incompatibility with other systems, and obsolescence. Custom designs also utilize specialized test equipment for system integration and verification.

Recognizing the gradual move to Ethernet and distributed computing in non-aerospace industries, Aeronautical Radio, Incorporated, (ARINC) and the Airlines Electronic Engineering Committee (AEEC), working in cooperation with the aerospace industry, began to define a deterministic protocol for real time application on Ethernet media. The resulting standard that was formally released on 27 Jun. 2005 as ARINC 664 Part 7 and is now widely known as Avionics Full Duplex Switched Ethernet, or AFDX. However, AFDX is very different from IEEE 802.3 as a communications protocol. For example, an important component of AFDX is an AFDX End System, which is a specialized subsystem that is generally embedded in each avionics component that is connected to the AFDX network. AFDX does not take advantage of all the benefits inherent to IEEE 802.3 because it does not implement a CCDL interface with an IEEE standard Ethernet based network. Example embodiments address this as well as other disadvantages of the related art.

### SUMMARY

According to an example embodiment, a method includes communicating between redundant Flight Control Computers (FCCs) using Cross-Channel Data Links (CCDLs) that operate in accordance with an IEEE standard Ethernet protocol.

### BRIEF DESCRIPTION OF THE DRAWINGS

Example embodiments are described in further detail below with reference to the following drawings, in which:

FIG. 1 is a block diagram illustrating a part of a flight control system in accordance with an example embodiment of the invention;

FIG. 2 is a block diagram illustrating a network configuration in accordance with an example embodiment of the invention;

FIG. 3 is a block diagram illustrating a network configuration in accordance with an example embodiment of the invention; and

FIG. 4 is a block diagram illustrating a network configuration in accordance with an example embodiment of the invention.

### DETAILED DESCRIPTION

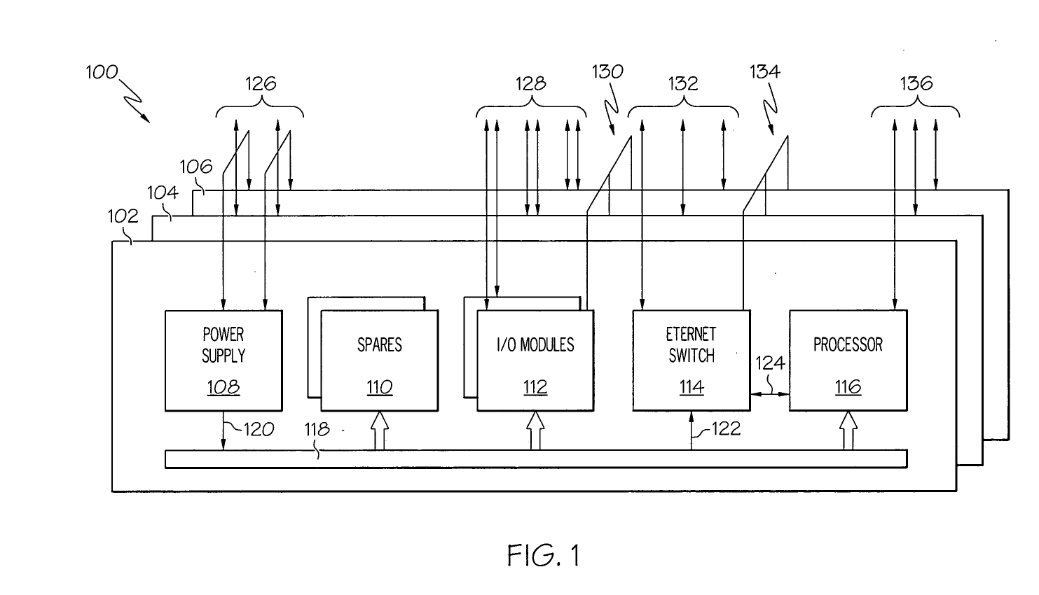

FIG. 1 is a block diagram illustrating some components of an aircraft flight control system 100 in accordance with an example embodiment. As illustrated in FIG. 1, the aircraft flight control system 100 includes redundant FCCs 102, 104, 106, where the FCCs 104, 106 have a similar construction to the FCC 102. According to the example embodiment, each of the FCCs 102, 104, 106 may be a single Line Replaceable Unit, or LRU. A LRU describes an aircraft component that may be replaced or swapped out with another LRU of the same construction directly on the flight line.

The FCC 102 includes an embedded processor 116, a multi-port managed Ethernet switch 114 that is controlled by the processor through interface 124, and two standard Ethernet data links 132, 134. Alternative embodiments may include more than two standard Ethernet data links, and in alternative embodiments the Ethernet data links 132, 134 may be Gigabit Ethernet data links. Like the embodiment of FIG. 1, other example embodiments may apply standard Ethernet technology to Flight Control applications. Standard Ethernet technology is desirable, in part, because of its maturity, continual growth and development, and inherent obsolescence mitigation due to its wide acceptance. For purposes of this disclosure, standard Ethernet shall refer to any communications protocol that follows an IEEE standard, such as IEEE 802.3.

According to this example embodiment, the embedded processor 116 is a 7447 PowerPC CPU. According to the example embodiment, the standard Ethernet data link 132 is a vehicle interface data link that is configured to connect the multi-port managed Ethernet switch 114 to other aircraft systems (not shown). According to the example embodiment, the standard Ethernet data link 134, in this case utilized as a CCDL, is configured to connect the multi-port managed Ethernet switch 114 to other multi-port managed Ethernet switches on FCC 104 and FCC 106.

According to the example embodiment, the FCC 102 further includes a power supply 108, spare modules 110, and General Purpose I/O (GPIO) modules 114. A bus 118 carrying power, data, and address signals forms the backplane between the spares 110, the GPIO modules 112, and the embedded processor 116. The power supply 108 supplies power to the bus 118 through interface 120, while the multi-port managed Ethernet switch 114 receives power from the bus 118 through interface 122. Thus, in this example embodiment, the multi-port managed Ethernet switch 114 and the power supply 108 do not use address or data signals from the bus 118.

The power supplies 108 on FCCs 102, 104, 106 are connected to aircraft power through interface 126. Interface 128 to and from the GPIO modules 112 may include serial interfaces such as RS422, RS485, or MIL-STD-1553; analog interfaces; discrete interfaces, frequency interfaces; stepper motor interfaces; or resistance thermal detector (RTD) interfaces. Interface 136 to and from the embedded processor 116 may include serial interfaces such as RS232 RS422, RS485, or Ethernet. Interface 136 may also include a discrete interface. According to the embodiment, the serial interfaces may include internal buffers to maximize processing throughput.

The multi-port managed Ethernet switch 114 has internal switch controllers that are physically connected to the external ports to enable routing among the CCDL 134 that is connected to these ports. With the use of the multi-port managed Ethernet switch 114, bus collisions are avoided and message traffic becomes a switched point to point architecture.

The use of multi-port managed Ethernet switches 114 on each of the FCCs 102, 104, 106 allows full access and control of vehicle Ethernet interfaces from any one of the FCCs. The CCDL 134 uses the Ethernet interface, which is routed to the multi-port managed Ethernet switch 114, to pass data. The CCDL 134 can use the higher Gigabit networks as the CPU cards support this data rate. In addition to the higher speed, the multi-port managed Ethernet switch 114 can be configured to use the minimum layer 2 operations for these ports by passing data using Media Access Control (MAC) addresses. A serial port or an Ethernet port may be used to setup and configure the multi-port managed Ethernet switch 114. There are many configurations and flexibility available when using a multi-port managed Ethernet switch 114. Two example network configurations that use multi-port managed Ethernet switches and Ethernet data links to implement a CCDL are discussed in further detail below.

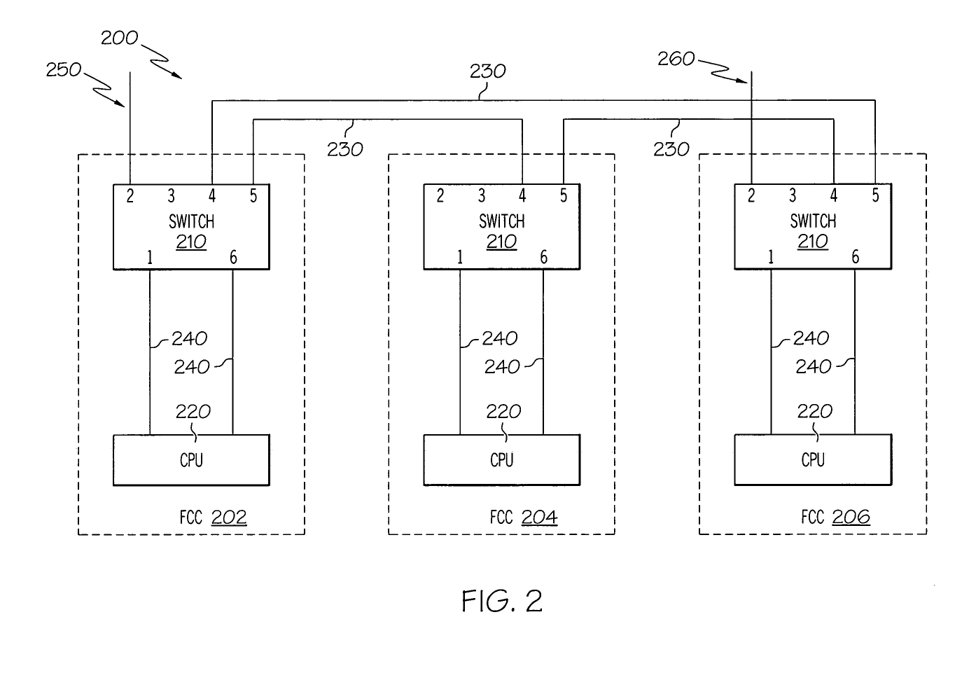

FIG. 2 is a block diagram illustrating a network configuration 200 in accordance with an example embodiment. Each of the FCCs 202, 204, 206 include a multi-port managed Ethernet switch 210 and a CPU module 220. The network configuration 200 illustrates a triplex configuration, but in alternative embodiments the number of FCCs may be greater than or less than three.

In network 200, ports 4 and 5 of the multi-port managed Ethernet switch 210 are used to connect the multi-port managed Ethernet switch to the other multi-port managed Ethernet switches in the network. These connections form CCDLs 230 between the multi-port managed Ethernet switches 210.

Multi-port managed Ethernet switch 210 of FCC 202 may be linked to another aircraft avionics system (not shown) using interface 250 connected to port 2. Multi-port managed Ethernet switch 210 of FCC 206 may be linked to a laptop computer (not shown) using interface 260 connected to port 3. Data may be exchanged between interfaces 250 and 260 using the CCDLs 230. For example, a flight test engineer, operating the laptop computer that is connected to interface 260 may receive system status data from the avionics system that is connected to interface 250.

Ports 1 and 6 of each multi-port managed Ethernet switch 210 are connected to their respective CPU modules 220 using Ethernet Data Links 240. In the example embodiment, one of the Ethernet Data Links 240 for each multi-port managed Ethernet switch 210 is used for processing CCDL traffic. The other one of the Ethernet Data Links 240 is used to support vehicle interface traffic, for example, traffic sent to or received from the interfaces 250 and 260.

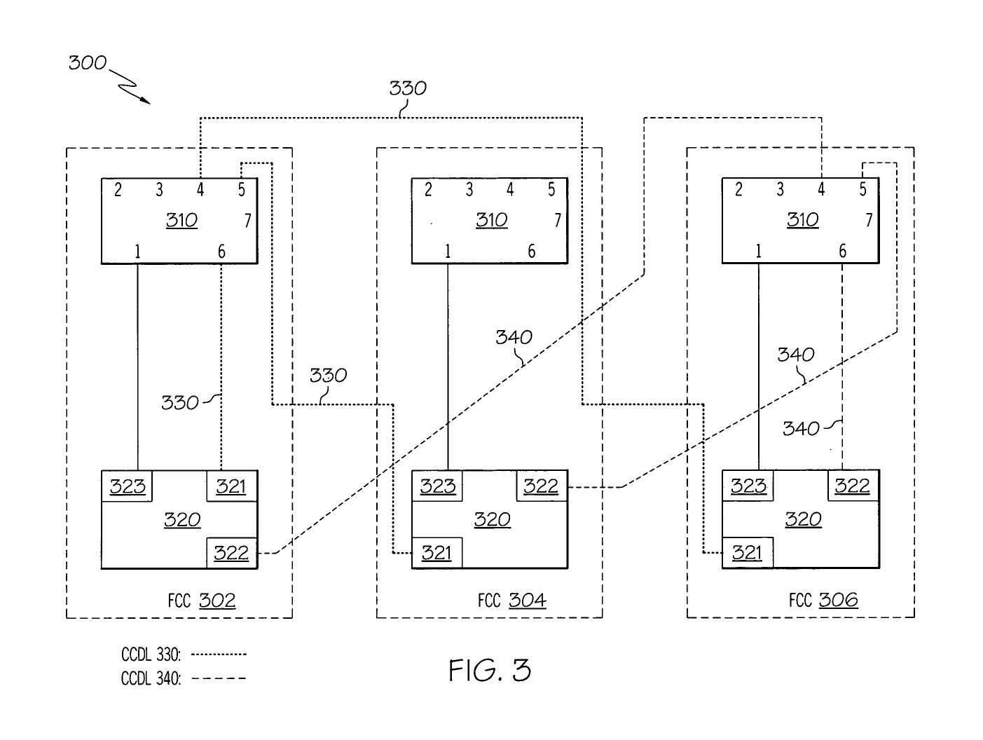

FIG. 3 is a block diagram illustrating a network configuration 300 in accordance with an example embodiment. The network 300 illustrates a triplex configuration that includes three FCCs 302, 304, 306 where each of the FCCs includes a multi-port managed Ethernet switch 310 and a CPU module 320.

In network configuration 300, the multi-port managed Ethernet switches 310 each include seven ports (numbered 1-7), but in other embodiments the number of ports in each multi-port managed Ethernet switch may be greater or less than seven, and furthermore each multi-port managed Ethernet switch may have a different number of ports than other multi-port managed Ethernet switches. In this embodiment, the CPU modules 320 each have three Ethernet links (numbered 1-3), but in other embodiments the number of Ethernet links may be greater or less than three, and furthermore each CPU module may have a different number of Ethernet links than other CPU modules.

Network configuration 300 illustrates two redundant CCDLs that utilize the multiple Ethernet links 321, 322, 323 on each of the CPU modules 320. CCDL 330, indicated with dotted lines, utilizes Ethernet link 321 on each of the CPU modules 320. CCDL 340, indicated with dashed lines, utilizes Ethernet link 322 on each of the CPU modules 320. Since each Ethernet link 321, 322, 323 on the CPU modules 320 has its own MAC address, each functions as a separate node on the network. Network configuration 300 uses the multi-port managed Ethernet switches 310 in FCCs 302 and 306 as the junction for two Ethernet networks, which can operate concurrently in an active-active mode, or one network may be used as backup in an active-standby mode.

In an active-standby mode of operation, CCDL 330 may be part of the primary network while CCDL 340 is part of the backup network. When the primary network is used the CPU modules 320 access their Ethernet link 330 to transmit and receive data to and from their partner FCCs using the multi-port managed Ethernet switch 310 in FCC 302. For example, when FCC 302 is transmitting to the other two FCCs 304 and 306, the multi-port managed Ethernet switch 320 in FFC 302 will route a transmit message from port 6 over to port 4 or port 5, depending on the destination address embedded in the message protocol.

If the backup network is used in the active-standby mode of operation, the CPU modules 320 access their Ethernet link 322 to transmit and receive data to and from their partner FCCs using the multi-port managed Ethernet switch 310 in FCC 306. For example, when FCC 306 is transmitting to the other two FCCs 302 and 304, the multi-port managed Ethernet switch 320 in FFC 306 will route a transmit message from port 6 over to port 4 or port 5, depending on the destination address embedded in the message protocol.

Ethernet link 323 on each CPU module 320 is used to support vehicle interfacing, which is independent of the inter-FCC CCDLs. To further isolate the vehicle and CCDL data, each subsystem may use ports on the multi-port managed Ethernet switch 310 that are connected to separate switching components on the circuit card. Other vehicle interfaces can be added to the empty ports of the multi-port managed Ethernet switches 310 to route traffic to Ethernet link 323 of the CPU module 320, independently of CCDL 330 and CCDL 340.

The wiring of the FCCs may be configured to allow external cabling to facilitate network configurations. As shown in network configuration 300, FCCs 302 and 306 each have two internal connections between ports on the multi-port managed Ethernet switch 310 and Ethernet links on the CPU module 320, while FCC B has one internal connection. The remaining Ethernet links on each CPU module may be brought out to the front panel interfaces, allowing different configurations to be achieved using the external cabling. That is, Ethernet link 321 of CPU module 320 of FCC 302 could be connected to a different port simply by moving an end of the external cabling to the appropriate front panel interface for that port.

The redundancy described above for network configuration 300 may be implemented in software. That is, the multi-port managed Ethernet switches 310 and the CCDLs provide the framework, while the software for the CPU modules 320 command an alternate Ethernet data link. Alternatively, a combination of hardware, software, and firmware could be used.

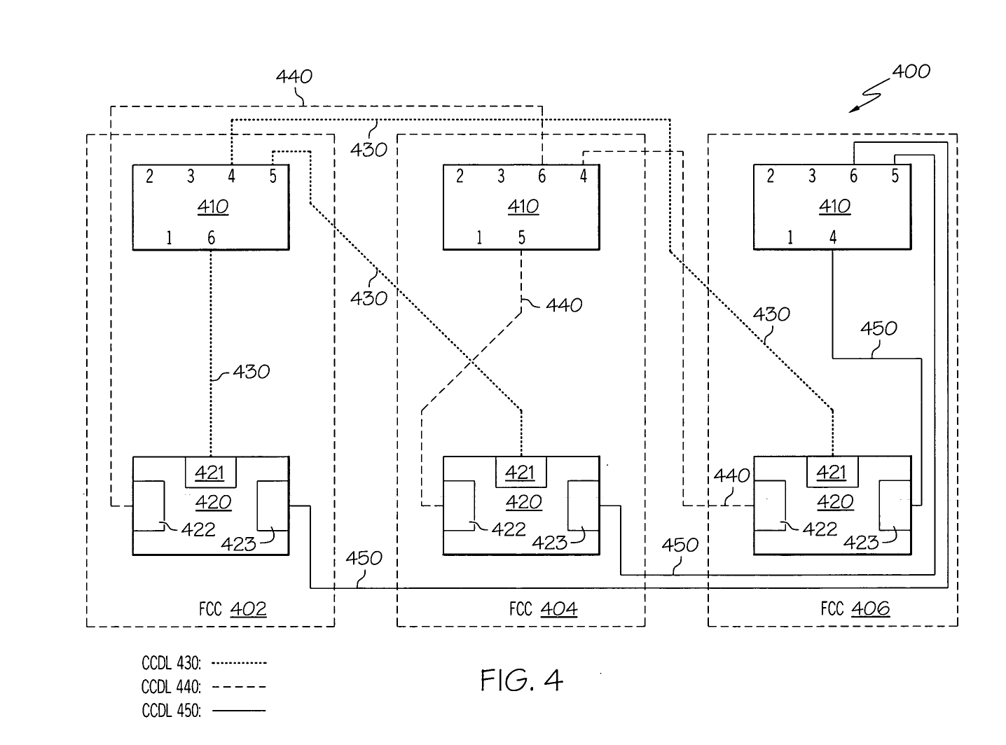

FIG. 4 is a block diagram illustrating a network configuration 400 in accordance with an example embodiment. The network 400 illustrates a triplex configuration that includes three FCCs 402, 404, 406 where each of the FCCs includes a multi-port managed Ethernet switch 410 and a CPU module 420.

In network configuration 400, the multi-port managed Ethernet switches 410 each include six ports (numbered 1-6), but in other embodiments the number of ports in each multi-port managed Ethernet switch may be greater or less than six, and furthermore each multi-port managed Ethernet switch may have a different number of ports than other multi-port managed Ethernet switches. In the embodiment, the CPU modules 420 each have three Ethernet links 421, 422, 423 but in other embodiments the number of Ethernet links may be greater or less than three, and furthermore each CPU module may have a different number of Ethernet links than other CPU modules.

Network configuration 400 illustrates three redundant CCDLs 430, 440, 450 that utilize the multiple Ethernet links 421, 422, 423 on each of the CPU modules 420. CCDL 430, indicated with dotted lines, utilizes Ethernet link 421 on each of the CPU modules 420. CCDL 440, indicated with dashed lines, utilizes Ethernet link 422 on each of the CPU modules 420. CCDL 450, indicated with solid lines, utilizes Ethernet link 423 on each of the CPU modules 420. Since each Ethernet link 421, 422, 423 on the CPU modules 420 has its own MAC address, each functions as a separate node on the network.

According to alternative embodiments, the Ethernet links 421, 422, 423 may be Gigabit Ethernet links.

Network configuration 400 uses the multi-port managed Ethernet switches 410 in FCCs 402, 404, 406 as the junction for three Ethernet networks. The multi-port managed Ethernet switches 410 in the FCCs are used to isolate the CCDLs 430, 440, 450 to provide three sources of routing. The Ethernet links 421, 422, 423 may be operated concurrently as active links or there may be one pair of active links with the third Ethernet link used as a backup link.

Each CPU module 420 in each FCC will transmit and receive on the CCDLs using Ethernet links 421, 422, 423 and the corresponding multi-port managed Ethernet switch 410. For example, when FCC 402 is transmitting to the other two FCCs, the multi-port managed Ethernet switch 410 in FCC 402 will route a transmit message from port 6 over to port 4 or 5, depending on the destination address embedded in the message protocol.

The wiring of the FCCs may be configured to allow external cabling to facilitate network configurations. As shown in network configuration 400, the FCCs 402, 404, 406 each have one internal connection between a port on the multi-port managed Ethernet switch 410 and an Ethernet link on the CPU module 420. Specifically, these internal connections are the internal connection between Ethernet link 421 and port 6 in FCC 402, the internal connection between Ethernet link 422 and port 5 in FCC 404, and the internal connection between Ethernet link 423 and port 4 in FCC 406. The remaining Ethernet links on each CPU module 420 may be brought out to the front panel interfaces, allowing different configurations to be achieved using the external cabling. That is, Ethernet link 422 of CPU module 420 of FCC 402 could be connected to a different port of the multi-port managed Ethernet switch 410 in FCC 404 simply by repositioning an end of the external cabling to the appropriate front panel interface for that port.

The redundancy described above for network configuration 400 may be implemented in software. That is, the multi-port managed Ethernet switches 410 and the CCDLs provide the framework, while the software for the CPU modules 420 command an alternate Ethernet data link.

Table 1, which appears below, illustrates the switch routing for triplex communications in the network configuration 400. For example, Table 1 illustrates that when FCC 404 and FCC 406 communicate, port 4 is routed to port 5. Routings are based on managed switch tables built using Media Access Control (MAC) addresses, which are unique addresses for each of the Ethernet links 421, 422, 423 on the CPU modules 420. These addresses are embedded in the Ethernet protocol accompanying each message and are used to perform the switching. In the network configuration 400, there are a total of nine unique MAC addresses, one address for each of the nine Ethernet links.

TABLE 1

| Data Exchange | Routing |
|---|---|
| FCC 402-FCC 404 | Port 6-Port 5 |
| FCC 402-FCC 406 | Port 6-Port 4 |
| FCC 404-FCC 402 | Port 5-Port 6 |
| FCC 404-FCC 406 | Port 5-Port 4 |
| FCC 406-FCC 402 | Port 4-Port 6 |
| FCC 406-FCC 404 | Port 4-Port 5 |

In a frame synchronous system a contention situation may arise where the CPU modules 420 may be executing the same software resulting in simultaneous messages to FCC 402 from FCCs 404 and 406. Another scenario may result in FCC 404 and FCC 406 exchanges while FCC 402 is attempting to transmit to them. These conditions would be reflected at the managed switch as simultaneous routing among ports 4, 5, and 6. A calculated amount of simultaneous routing conditions can be handled on the multi-port managed Ethernet switches 410 depending on the internal RAM buffers. Data is acquired and buffered and routed to the required ports in a managed approach depending on the configuration (e.g., priority, round robin) without any data loss and very low latency. If no contention exists, the data transfer may be near wire speed.

According to example embodiments, the CPU modules 320 of FIG. 3 and the CPU modules 420 may use standard Ethernet protocol, such as Transmission Control Protocol/Internet Protocol (TCP/IP) or Ethernet frame protocol, to process messages. However, the lower level Ethernet frame protocol is preferred because of timing advantages.

If two primaries and one backup CCDL are a desired configuration, traffic can be directed to the primary or secondary networks by the software application via redundancy management routines that will direct the current CPU data link as Ethernet link 1, 2 or 3 by using MAC addresses.

Data links can fail and manifest themselves in the receiver as periodic or continuous. An example of a periodic failure would be messages that fail for data integrity resulting in corrupt data. This would be seen in a receiver as invalid data or no data at all. A continuous failure would result in the transmitter continually spewing data and tying up all bandwidth on the data link. This may also be referred to as a babbling bus failure. Both periodic and continuous failures are detectable using typical CPU hardware resources such as interrupts and timers or software.

Network redundancy determination is accomplished using a compilation of diagnostics from a series of message verifications, timing data, and Built-In Test (BIT) messages. For message verifications Cyclic Redundancy Checks (CRCs) or sumchecks may be used. For timing messages a series of allocation tables are used for timing verifications.

Sumchecks are used with higher level protocols such as TCP/IP protocol and will flag invalid data. CRCs are used in the basic Ethernet frame protocol and can also flag an error in the absence of the higher level protocols. When each message is passed among FCCs, the CRC or sumcheck is verified and if repetitive failures are observed by multiple receiving FCCs, a switchover to the backup link is initiated. A control message is sent on the backup link to alert the offending FCC to shutdown its primary link and switch over to the backup link.

Since traffic/message structure is generally known and configured in software a priori, a series of Tables can be built with various thresholds to describe this traffic. The babbling bus failure mode can be isolated and captured using software to detect an inordinate period of continuous messages. As messages arrive in a receiving FCC, a timer may be activated and the resultant message arrival times may be recorded. If timing between messages falls outside a defined window provided in an allocation Table, this port is shutdown and another link is activated to notify the offending sender to also switchover to this link. In the event that a CPU module is at fault and spewing data on multiple links, the receivers may shutdown their listening ports and hardware discretes among FCCs may be used to provide a shutdown signal to the offending FCC.

BIT routines may circulate a test message and request an encoded echoback message from receiving FCCs at predetermined intervals of time. These echoback messages serve as test as well as synchronization (sync) messages. If this message is not received, FCCs may note this in a series of diagnostic data. A penalty may be assessed for each invalid reception and a recovery count may be subtracted for each valid reception. The penalty or recovery assessment may occur at a frequency that is dependent on the transmission or reception rate. A pre-determined threshold may indicate when an FCC data link is taken off-line. These test and sync messages can also be used to trigger message transmission to maintain a synchronous data set among FCCs. This configuration may also be used in an all active mode where concurrent transmissions are sent on all links and receiving CPU modules vote data. Any divergence of data indicates invalid messages, and echoback messages that implement a penalty/recovery system as described above may also be used to assess a faulty link.

There are numerous standard hardware subsystems and features that lend themselves to specifically support an implementation for switched Ethernet CCDL interfacing for redundant FCCs, such as the embodiments described above. By using a network that incorporates some of these hardware components and features, a CCDL for redundant FCCs may be obtained that is superior to conventional solutions that implement custom designs.

For example, managed Ethernet switches are widely available and Ethernet links are magnetically isolated for fault tolerance. Ethernet protocol is widely understood, eliminating driver and software development, and network monitoring may be easily accommodated using commercially available tools. The reliability of the network may be enhanced by implementing software monitoring routines. Additionally, most embedded CPU boards contain Ethernet interfaces. As these CPU boards become more powerful, their Ethernet links keep pace with higher speeds and multiple links. Gigabit Ethernet runs on multiple links at a speed of 125 MHz with 5 state signaling for robust error detections and an aggregate rate of 1 GHz. These multiple links running at lower rates make Gigabit Ethernet more Electro-Magnetic Interference (EMI) compatible compared to using a single 1 GHz link. EMI compatibility and signal integrity may also be improved through the use of high-speed, impedance matched interconnects, such as Quadrax interconnects, as well as Quadrax cable.

Because switch-based Ethernet systems have such a broad user base, the risk of latent design issues is reduced as newer technologies are fielded. Development efforts and costs are shifted to the commercial industry, which has volume to easily absorb this burden and provide for continued support development. The integration effort is facilitated using a standard PC with widely available Ethernet monitoring software that can be passively interfaced to the network to capture and analyze data transfers. Switch-based Ethernet systems can also be used to grow with vehicle throughput and performance requirements as the commercial world's network infrastructures and bandwidth demands continue to drive and virtually guarantee this systems roadmap. Upgrade hardware is designed where backwards compatibility is readily addressed. For example, Local Area Networks (LANS) can be upgraded to Gigabit Ethernet with little impact. Current software-based test tools can continue to be used, although test hardware may be upgraded with Commercial Off-The-Shelf (COTS) systems.

While at least one example embodiment has been presented in the foregoing detailed description, it should be appreciated that a vast number of variations exist. It should also be appreciated that the example embodiment or example embodiments are not intended to limit the scope, applicability, or configuration of the invention in any way. Rather, the foregoing detailed description will provide those skilled in the art with a convenient road map for implementing the inventive aspects that may be found in at least one embodiment. The inventor regards the subject matter of the invention to include all combinations and subcombinations of the various elements, features, functions and/or properties disclosed in the example embodiments. It should be further understood that various changes can be made in the function and arrangement of elements without departing from the scope of the invention as set forth in the appended claims and the legal equivalents thereof.

1. A Flight Control Computer (FCC) comprising:
a processor configured to communicate in accordance with a standard IEEE Ethernet protocol;
an Ethernet switch configured to communicate in accordance with the standard IEEE Ethernet protocol; and
a first Ethernet data link coupling the processor and the Ethernet switch for communication in accordance with the standard IEEE Ethernet protocol.

2. The FCC of claim 1, the standard IEEE Ethernet protocol comprising IEEE 802.3.

3. The FCC of claim 1, the standard IEEE Ethernet protocol comprising Gigabit Ethernet.

4. The FCC of claim 1, further comprising:
an external interface; and
a second Ethernet data link coupling the processor and the external interface for communication in accordance with the standard IEEE Ethernet protocol.

5. The FCC of claim 4, the processor configured to process messages received on the first and the second Ethernet data links using Transmission Control Protocol/Internet Protocol (TCP/IP).

6. The FCC of claim 4, the processor module configured to process messages received on the first and the second Ethernet data links using Ethernet frame protocol.

7. The FCC of claim 4, wherein the first and the second Ethernet data links are configured to operate concurrently.

8. A flight control system comprising:
a first processor module including a first Ethernet data link, a second Ethernet data link, and a third Ethernet data link;
a first Ethernet switch module operable to communicate with the first processor module according to an IEEE Ethernet standard using the first Ethernet data link;
a second processor module including a fourth Ethernet data link, a fifth Ethernet data link, and a sixth Ethernet data link, the second processor module operable to communicate with the first Ethernet switch module according to the IEEE Ethernet standard using the fourth Ethernet data link; and
a second Ethernet switch module operable to communicate with the second processor module according to the IEEE Ethernet standard using the fifth Ethernet data link.

9. The flight control system of claim 8, the first processor module operable to communicate with the second Ethernet switch module according the IEEE Ethernet standard using the second Ethernet data link.

10. The flight control system of claim 9, further comprising:
a third processor module including a seventh Ethernet data link, an eighth Ethernet data link, and a ninth Ethernet data link, the third processor module operable to communicate with the second Ethernet switch module according to the IEEE Ethernet standard using the seventh Ethernet data link.

11. The flight control system of claim 10, further comprising a third Ethernet switch module operable to communicate with the third processor module according to the IEEE Ethernet standard using the eighth Ethernet data link.

12. The flight control system of claim 11, the first processor module operable to communicate with the third Ethernet switch module according to the IEEE Ethernet standard using the third Ethernet data link.

13. The flight control system of claim 12, the second processor module operable to communicate with the third Ethernet switch module according to the IEEE Ethernet standard using the sixth Ethernet data link.

14. The flight control system of claim 13, the third processor module operable to communicate with the first Ethernet switch module according to the IEEE Ethernet standard using the ninth Ethernet data link.

15. A method comprising the steps of:
establishing a first Cross Channel Data Link (CCDL) between a first Flight Control Computer (FCC) and a second FCC, the first CCDL operating in accordance with an IEEE standard Ethernet protocol; and
establishing a second Cross Channel Data Link (CCDL) between the first FCC and the second FCC, the second CCDL operating in accordance with the IEEE standard Ethernet protocol.

16. The method of claim 15, wherein establishing the first CCDL comprises:
linking a first Ethernet data link embedded in a first processor module of the first FCC to a first Ethernet switch module of the first FCC; and
linking the first Ethernet switch module of the first FCC to a second Ethernet data link embedded in a second processor module of the second FCC.

17. The method of claim 16, wherein establishing the second CCDL comprises:
linking a third Ethernet data link embedded in the second processor module of the second FCC to a second Ethernet switch module of the second FCC; and
linking the second Ethernet switch module of the second FCC to a fourth Ethernet data link embedded in the first processor module of the first FCC.

18. The method of claim 17, further comprising establishing a third CCDL between a third FCC and the first and second FCCs, the third CCDL operating in accordance with the IEEE standard Ethernet protocol.

19. The method of claim 18, wherein establishing the third CCDL comprises:
linking a fifth Ethernet data link embedded in a third processor module of the third FCC to a third Ethernet switch module of the third FCC;
linking the third Ethernet switch module to a sixth Ethernet data link embedded in the first processor module of the first FCC; and
linking the third Ethernet switch module to a seventh Ethernet data link embedded in the second processor module of the second FCC.

20. The method of claim 19, further comprising establishing routing tables for the first Ethernet switch module, the second Ethernet switch module, and the third Ethernet switch module using a unique Media Access Control (MAC) address that is assigned to each one of the first, second, third, fourth, fifth, sixth, and seventh Ethernet data links.
